(19) United States
(12) Patent Application Publication
(10) Pub. No.: US 2016/0046833 A1
(43) Pub. Date: Feb. 18, 2016

(54) COATING LIQUID, LAMINATE, OPTICAL INSTRUMENT AND ELECTRONIC EQUIPMENT

(71) Applicant: IDEMITSU KOSAN CO., LTD., Tokyo (JP)

(72) Inventor: Hironobu MORISHITA, Chiba (JP)

(73) Assignee: IDEMITSU KOSAN CO LTD., Tokyo (JP)

(21) Appl. No.: 14/783,332

(22) PCT Filed: Apr. 4, 2014
(86) PCT No.: PCT/JP2014/059971

§ 371 Date: Oct. 8, 2015

(30) Foreign Application Priority Data
Apr. 8, 2013 (JP) 2013-080786

(51) Int. Cl. C09D 169/00

(52) U.S. Cl. CPC C09D 169/00

(57) ABSTRACT

A laminate includes a resin base material having a glass transition temperature of 150 degrees C. or less and a polycarbonate resin layer formed by applying a coating liquid containing a polycarbonate resin to the resin base material, in which the polycarbonate resin contained in the coating liquid has a repeating unit represented by a formula (I) below,

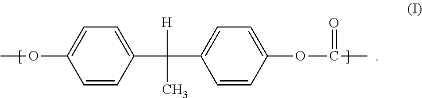

### TECHNICAL FIELD

The present invention relates to a coating liquid, a laminate, an optical device and an electronic device.

### BACKGROUND ART

Polycarbonate resins have been used as a material for molded products in various industrial fields in terms of its excellent mechanical characteristics, thermal characteristics and electrical characteristics. Recently, polycarbonate resins have often been used in a field of a functional product requiring optical characteristics of polycarbonate resins as well as the above characteristics. With expanding usage and applied field of polycarbonate resins, performance required in polycarbonate resins has been diversified.

However, a typically used homopolymer of polycarbonate resins made from materials such as 2,2-bis(4-hydroxyphenyl)propane (bisphenol A) and 1,1-bis(4-hydroxyphenyl)cyclohexane (bisphenol Z) is occasionally insufficient for such a demand. Accordingly, polycarbonate copolymers having various chemical structures have been proposed. For instance, Patent Literatures 1 to 6 disclose examples of a homopolymerized or copolymerized polycarbonate made from 1,1-bis(4-hydroxyphenyl)ethane (bisphenol E).

### CITATION LIST

### Patent Literatures

Patent Literature 1: JP-A-60-243115

Patent Literature 2: JP-A-61-42537

Patent Literature 3: JP-A-6-32974

Patent Literature 4: JP-A-2001-215739

Patent Literature 5: JP-A-2005-173560

Patent Literature 6: U.S. Pat. No. 3,275,601

### SUMMARY OF THE INVENTION

### Problems to be Solved by the Invention

The inventors studied a laminate such as a plastic film and a sheet having a resin base material of which a surface has various functions such as antifouling property, heat resistance, mechanical strength such as hardness, optical characteristics and electrical characteristics, and advanced the study for application of the laminate. Examples of the application of the laminate include a film for in-mold forming, a decorative film, a touch panel film used for a liquid crystal display and an organic EL display, an optical film such as an optical compensation film and an antireflection film, and an electroconductive film.

In such circumstances, the inventors manufactured a laminate film by applying a coating liquid, which is prepared by dissolving a polycarbonate resin in a solvent, on a surface of a resin base material and studied application of the laminate film to the above-described usage. The resin base material is generally formed of a polycarbonate resin, a polyester resin such as polyethylene terephthalate (PET), an acrylic resin, a polyolefin resin or the like.

Firstly, a polycarbonate resin obtained by polymerizing bisphenol A (starting material), which is abbreviated as a BisA polycarbonate resin hereinafter, was studied. The BisA polycarbonate resin has appropriate heat resistance, mechanical strength and molding-processability. As a molding method of the BisA polycarbonate resin, a melt molding method of melting a resin mainly by heat and molding the melt resin by injection or extrusion is usable. The BisA polycarbonate resin has a poor solubility in an organic solvent and a poor solution stability, but can be dissolved in a halogen solvent such as dichloromethane and chloroform. However, since use of the halogen solvent requires strict management and the like, the use thereof is restricted. For this reason, the BisA polycarbonate resin is inappropriate for a type of laminate film to be manufactured by applying a coating liquid.

Next, a polycarbonate resin obtained by polymerizing the above-described bisphenol Z (starting material), which is abbreviated as a BisZ polycarbonate resin hereinafter, was studied. The BisZ polycarbonate resin can be dissolved even in a non-halogen solvent. However, since the BisZ polycarbonate resin has a glass transition temperature (Tg) as high as about 175 degrees C., removal of a residual solvent in a drying process is difficult. Accordingly, an influence by the residual solvent, a decrease in a production efficiency caused by raising or prolonging the drying temperature for enforcing the drying, a decrease in a quality of the coated product, and the like are given. Since the above-described resin forming the resin base material has a glass transition temperature lower than 150 degrees C., when the coating liquid containing the BisZ polycarbonate resin is applied to the resin base material, dried at high temperatures and molded, the resin base material may be discolored or deformed.

Next, a polycarbonate resin obtained by polymerizing the above-described bisphenol E (starting material), which is occasionally abbreviated as a BisE polycarbonate resin hereinafter, was studied. Patent Literatures 1, 2 and 3 disclose improvement in fluidity during melt molding. Patent Literatures 4 and 5 disclose an electrophotographic photosensitive body obtained by dissolving copolymerized polycarbonate containing bisphenol E in tetrahydrofuran (THF), applying the obtained solution, and molding. Patent Literature 6 discloses a cast film manufactured by melting a polycarbonate resin in various organic solvents such as methylene chloride. Although Patent Literatures 4 and 5 disclose the electrophotographic photosensitive body produced by applying the BisE polycarbonate resin on an electroconductive substrate, Patent Literatures 4 and 5 fail to disclose a laminate obtained by laminating the BisE polycarbonate resin on a resin base material and fail to sufficiently study the laminate.

The invention was achieved under such circumstances. An object of the invention is to provide a laminate that contains less residual solvent to be able to be dried for a short time while deformation and discoloration of a resin base material are suppressed and that exhibits excellent mechanical strength, appearance and electrical characteristics, and to provide an optical device and an electronic device using the laminate. Another object of the invention is to provide a coating liquid to be used for manufacturing the laminate.

### Means for Solving the Problems

After a dedicated study for achieving the object, the inventors obtained the following findings.

Firstly, it was found that the polycarbonate resin obtained by polymerizing the bisphenol E (starting material) or the polycarbonate resin obtained by polymerizing the bisphenol E and divalent phenol in a specific structure (starting material) is stably dissolved in the non-halogen solvent (e.g., cyclohexanone, toluene, ethyl acetate, and methyl ethyl ketone). In other words, it was found that, according to the above polycarbonate resin, it is not necessary to use a halogen solvent that may adversely affect the environments and a solvent such as THF that has a safety problem (e.g., generation of peroxides and a low boiling point). Moreover, it was found that, since the above polycarbonate resin is stably dissolved even in an organic solvent (e.g., methyl ethyl ketone) having a boiling point of 100 degrees C. or less, the above polycarbonate resin can provide a coating liquid having a favorable coating performance and easy drying after the application of the coating liquid.

Secondly, it was found that, when the coating liquid provided by dissolving the polycarbonate resin described as the first finding in the non-halogen solvent is applied on a film used as a resin base material for an optical device and an electronic device (e.g., a polycarbonate film, a polyethylene terephthalate film, an acrylic film and a polyolefin film), a drying rate of the solvent is high to show easy drying.

Thirdly, it was found that the obtained laminate can exhibit excellent appearance, mechanical strength and moldability.

The invention has been achieved based on the above findings.

According to an aspect of the invention, a laminate includes: a resin base material having a glass transition temperature of 150 degrees C. or less; and a polycarbonate resin layer formed by applying a coating liquid containing a polycarbonate resin on the resin base material, in which the polycarbonate resin contained in the coating liquid has a repeating unit represented by a formula (I) below.

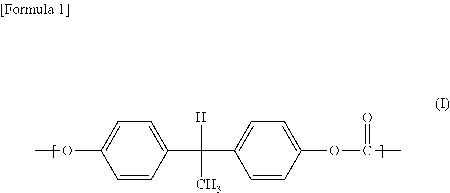

According to another aspect of the invention, an optical device uses the laminate according to the above aspect of the invention.

According to still another aspect of the invention, an electronic device uses the laminate according to the above aspect of the invention.

According to a further aspect of the invention, a coating liquid contains: a polycarbonate resin having a repeating unit represented by the formula (I); and at least one of a ketone solvent having a boiling point of 100 degrees C. or less and an ester solvent having a boiling point of 100 degrees C. or less.

According to the above aspect of the invention, a laminate that contains less residual solvent and can be dried for a short time while deformation and discoloration of a resin base material are suppressed and that exhibits excellent mechanical strength, appearance and electrical characteristics can be provided. Moreover, according to the another aspect of the invention, an optical device and an electronic device using the above laminate can be provided. Further, according to the still another aspect of the invention, a coating liquid to be used for manufacturing the above laminate can be provided.

### BRIEF DESCRIPTION OF DRAWINGS

FIG. 1 schematically shows a cross section of a laminate according to an exemplary embodiment of the invention.

### DESCRIPTION OF EMBODIMENT(S)

An exemplary embodiment of the invention will be described.

### Laminate

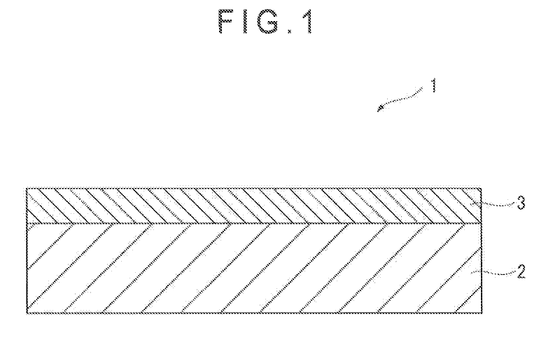

A laminate 1 in the exemplary embodiment includes a resin base material 2 and a polycarbonate resin layer 3 as shown in FIG. 1.

The resin base material 2 has a glass transition temperature of 150 degrees C. or less. The glass transition temperature of the resin base material 2 is preferably in a range from 65 degrees C. to 150 degrees C. The resin base material 2 is preferably formed of at least one of the group consisting of a polycarbonate resin, polyethylene terephthalate resin, polyolefin resin and acrylic resin. A form of the resin base material 2 can be selected in use from various forms such as a plate, sheet and film depending on a usage and an intended use of the laminate. The resin base material 2 is preferably light-transmissive, more preferably colorless and transparent.

The polycarbonate resin layer 3 is formed by applying a coating liquid containing a polycarbonate resin on the resin base material 2. In the exemplary embodiment, the polycarbonate resin layer 3 is formed directly on the resin base material 2. The coating liquid contains any one of polycarbonate resins A, B and C. Accordingly, the polycarbonate resin layer 3 formed by applying the coating liquid is formed of at least one of the polycarbonate resin A, polycarbonate resin B and polycarbonate resin C.

### Polycarbonate Resin A

In the exemplary embodiment, the polycarbonate resin A is a polycarbonate resin having a repeating unit represented by a formula (I) below.

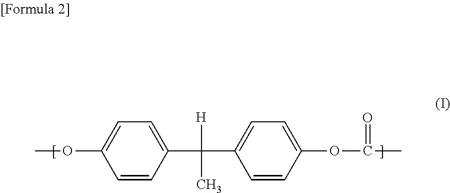

### Polycarbonate Resin B

In the exemplary embodiment, the polycarbonate resin B is a polycarbonate resin having the repeating unit represented by the formula (I) and a repeating unit represented by a formula (II) below.

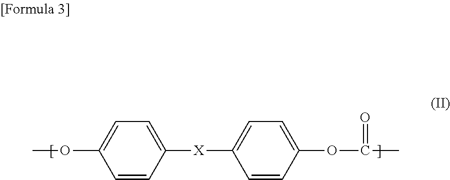

In the formula (II), X is a single bond or an oxygen atom. The formula (II) in which X is a single bond is represented by a formula (II-a) below. The formula (II) in which X is an oxygen atom is represented by a formula (II-b) below.

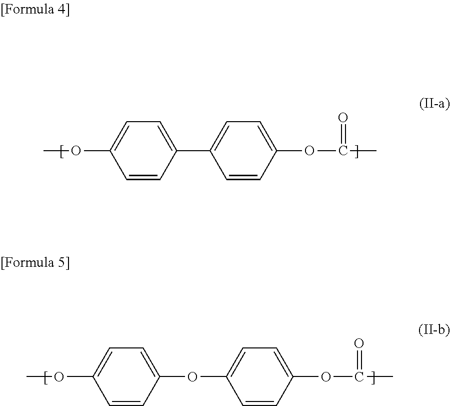

### Polycarbonate Resin C

In the exemplary embodiment, the polycarbonate resin C is a polycarbonate resin having the repeating unit represented by the formula (I) and a repeating unit represented by a formula (III) below.

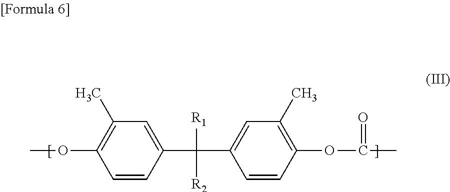

In the formula (III), R₁ and R₂ each independently represent a hydrogen atom or an alkyl group having 1 to 6 carbon atoms. R₁ and R₂ in the formula (III) may be bonded to each other to form a ring.

In the polycarbonate resin in the exemplary embodiment, a ratio between the repeating unit represented by the formula (I) and the repeating unit represented by the formula (II) and a ratio between the repeating unit represented by the formula (I) and the repeating unit represented by the formula (III) are not particularly limited.

However, a ratio of the repeating unit represented by the formula (II) to a sum of the repeating unit represented by the formula (I) and the repeating unit represented by the formula (II) is adjusted in terms of solubility of the polycarbonate resin in a non-halogen solvent, a suitable heat resistance, mechanical strength and the like. In the exemplary embodiment, the polycarbonate resin contained in the coating liquid preferably has heat resistance as high as a glass transition temperature (150 degrees C.) of BisA polycarbonate resin generally usable as an optical film. The glass transition temperature of the polycarbonate resin is important in order to prevent deformation (e.g., flexure) of a laminate film likely to be generated when heating and drying after the coating liquid is applied or when thermally molding (injection molding) the laminate film.

When X is a single bond in the repeating unit represented by the formula (II), in other words, in a biphenyl structure represented by the formula (II-a), a ratio of a mole number of the repeating unit represented by the formula (II) to a sum of a mole number M_{I} of the repeating unit represented by the formula (I) and the mole number M_{II} of the repeating unit represented by the formula (II) is preferably 40 mol % or less in order to provide the glass transition temperature of the polycarbonate resin at 150 degrees C. or less.

M_{II}/(M_{I}+M_{II})≦0.4

Further, it is desirable to optimize the above ratio to a more favorable ratio in terms of solubility and mechanical strength of the polycarbonate resin and types, heat resistance and strength of the resin base material 2. For instance, the above ratio is preferably 5% or more in terms of heat resistance and strength.

When X is an oxygen atom in the repeating unit represented by the formula (II), in other words, in a diphenyl ether structure represented by the formula (II-b), even when the ratio of the mole number M_{II} of the repeating unit represented by the formula (II) to the sum of the mole number M_{I} of the repeating unit represented by the formula (I) and the mole number M_{II} of the repeating unit represented by the formula (II) is 40 mol % or more, the glass transition temperature of the polycarbonate resin is not so different from the glass transition temperature (125 degrees C.) of the polycarbonate resin only formed by the repeating unit represented by the formula (I). Accordingly, an optimum composition can be selected depending on a material for the resin base material 2. Further, it is desirable to optimize the above ratio to a more favorable ratio in terms of solubility and mechanical strength of the polycarbonate resin and types, heat resistance and strength of the resin base material 2. For instance, the above ratio is preferably 5% or more in terms of heat resistance and strength.

Next, the polycarbonate resin C having the repeating unit represented by the formula (I) and the repeating unit represented by the formula (III) will be described. A ratio of a mole number M_{III} of the repeating unit represented by the formula (III) to a sum of the mole number M_{I} of the repeating unit represented by the formula (I) and the mole number M_{III} of the repeating unit represented by the formula (III) is preferably 50 mol % or less.

M_{III}/(M_{I}+M_{III})≦0.5

This is because the mechanical strength (e.g., tensile elongation) is decreased when the above ratio exceeds 50 mol %. Further, it is desirable to optimize the above ratio to a more favorable ratio in terms of solubility and mechanical strength of the polycarbonate resin and types, heat resistance and strength of the resin base material 2.

Examples of bisphenol forming the repeating unit represented by the formula (III) include 2,2-bis(3-methyl-4-hydroxyphenyl)butane, 1,1-bis(3-methyl-4-hydroxyphenyl)ethane, 2,2-bis(3-methyl-4-hydroxyphenyl)propane, 1,1-bis(3-methyl-4-hydroxyphenyl)cyclopentane, and 1,1-bis(3-methyl-4-hydroxyphenyl)cyclohexane.

Further, the polycarbonate resin contained in the coating liquid in the exemplary embodiment is not limited to the aforementioned polycarbonate resin as long as an object of the invention is not hampered. For instance, the polycarbonate resin may be obtained by copolymerizing bisphenol E for forming the repeating unit represented by the formula (I) with a bisphenol compound except for the bisphenol for forming the repeating unit represented by the formula (II) or (III). In this arrangement, examples of the bisphenol compound to be copolymerized with bisphenol E include 9,9-bis(3-phenyl-4-hydroxyphenyl)fluorene, bis(4-hydroxyphenyl)methane, 1,2-bis(4-hydroxyphenyl)ethane, 2,2-bis(4-hydroxyphenyl)butane, 2,2-bis(4-hydroxyphenyl)octane, 4,4-bis(4-hydroxyphenyl)heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl)ether, bis(4-hydroxyphenyl)sulfide, bis(4-hydroxyphenyl)sulfone, 1,1-bis(4-hydroxyphenyl)cyclopentane, 1,1-bis(4-hydroxyphenyl)cyclohexane, 2,2-bis(3-phenyl-4-hydroxyphenyl)propane, 2,2-bis(4-hydroxyphenyl)adamantane, 2,2-bis(3-methyl-4-hydroxyphenyl)adamantane, 1,3-bis(4-hydroxyphenyl)adamantane, 1,3-bis(3-methyl-4-hydroxyphenyl) adamantane, 2-(3-methyl-4-hydroxyphenyl)-2-(4-hydroxyphenyl)-1-phenylethane, bis(3-methyl-4-hydroxyphenyl) sulfide, bis(3-methyl-4-hydroxyphenyl)sulfone, bis(3-methyl-4-hydroxyphenyl)methane, 2,2-bis(2-methyl-4-hydroxyphenyl)propane, 1,1-bis(2-butyl-4-hydroxy-5-methylphenyl)butane, 1,1-bis(2-tert-butyl-4-hydroxy-3-methylphenyl)ethane, 1,1-bis(2-tert-butyl-4-hydroxy-5-methylphenyl)propane, 1,1-bis(2-tert-butyl-4-hydroxy-5-methylphenyl)butane, 1,1-bis(2-tert-butyl-4-hydroxy-5-methylphenyl)isobutane, 1,1-bis(2-tert-butyl-4-hydroxy-5-methylphenyl)heptane, 1,1-bis(2-tert-butyl-4-hydroxy-5-methylphenyl)-1-phenylmethane, 1,1-bis(2-tert-amyl-4-hydroxy-5-methylphenyl)butane, bis(3-chloro-4-hydroxyphenyl)methane, bis(3,5-dibromo-4-hydroxyphenyl)methane, 2,2-bis(3-chloro-4-hydroxyphenyl)propane, 2,2-bis(3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis(3,5-dichloro-4-hydroxyphenyl)propane, 2,2-bis(3,5-dibromo-4-hydroxyphenyl)propane, 2,2-bis(3-bromo-4-hydroxy-5-chlorophenyl)propane, 2,2-bis(3,5-dichloro-4-hydroxyphenyl)butane, 2,2-bis(3,5-dibromo-4-hydroxyphenyl)butane, 1-phenyl-1,1-bis(3-fluoro-4-hydroxyphenyl)ethane, bis(3-fluoro-4-hydroxyphenyl)ether, 3,3′-difluoro-4,4′-dihydroxybiphenyl, 1,1-bis(3-cyclohexyl-4-hydroxyphenyl)cyclohexane, 2,2-bis(4-hydroxyphenyl)hexafluoropropane, 1,1-bis(3-phenyl-4-hydroxyphenyl)cyclohexane, bis(3-phenyl-4-hydroxyphenyl)sulfone, 4,4′-(3,3,5-trimethylcyclohexylidene)diphenol, 4,4′-[1,4-phenylene bis(1-methylethylidene)]bisphenol, 4,4′-[1,3-phenylene bis(1-methylethylidene)]bisphenol, 9,9-bis(4-hydroxyphenyl)fluorene, and 9,9-bis(4-hydroxy-3-methylphenyl)fluorene. One of the above bisphenol compounds may be used alone, or two or more thereof may be used in combination.

Moreover, bisphenol except for the aforementioned bisphenol may further be copolymerized. For instance, bisphenol represented by a formula (VI) below is usable. Bisphenol represented by the formula (VI) below contains polysiloxane.

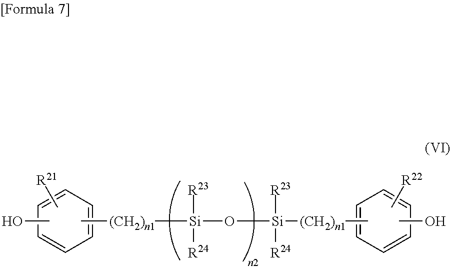

In the formula (VI), R²¹ and R²² each independently represent a hydrogen atom, a halogen atom, an alkyl group having 1 to 12 carbon atoms, an alkoxy group having 1 to 12 carbon atoms, or a substituted or unsubstituted aryl group having 6 to 12 ring carbon atoms.

R²³ and R²⁴ each independently represent an alkyl group having 1 to 12 carbon atoms, an alkoxy group having 1 to 12 carbon atoms, or a substituted or unsubstituted aryl group having 6 to 12 ring carbon atoms.

n1 each independently represents an integer from 2 to 4. n2 represents an integer from 25 to 220.

Examples of a halogen atom represented by R²¹ and R²² include a fluorine atom, a chlorine atom, a bromine atom and a iodine atom. Examples of the alkyl group having 1 to 12 carbon atoms represented by R²¹ and R²² include a methyl group, ethyl group, n-propyl group and isopropyl group. The substituted or unsubstituted aryl group having 6 to 12 ring carbon atoms represented by R²¹ and R²² is exemplified by a phenyl group. The substituent is exemplified by an alkyl group having 1 to 12 carbon atoms.

Examples of the alkyl group having 1 to 12 carbon atoms represented by R²³ and R²⁴ are the same as those of the alkyl group having 1 to 12 carbon atoms represented by R²¹ and R²², among which a methyl group is preferable. Specific examples of the alkyl group having 1 to 12 carbon atoms represented by R²³ and R²⁴ are the aforementioned examples of the alkyl group. The substituted or unsubstituted aryl group having 6 to 12 ring carbon atoms represented by R²³ and R²⁴ is exemplified by a phenyl group. The substituent is exemplified by an alkyl group having 1 to 12 carbon atoms. By introducing the above polysiloxane-containing bisphenol, water-oil repellency and slipperiness can be provided to the polycarbonate resin.

In the exemplary embodiment, “carbon atoms forming a ring (ring carbon atoms)” mean carbon atoms forming a saturated ring, an unsaturated ring, or an aromatic ring.

In the exemplary embodiment, a hydrogen atom includes isotope having different numbers of neutrons, specifically, protium, deuterium and tritium.

In the exemplary embodiment, “unsubstituted” in “substituted or unsubstituted” means that a group is not substituted by the above-described substituent but bonded with a hydrogen atom.

Herein, “a to b carbon atoms” in the description of “substituted or unsubstituted XX group having a to b carbon atoms” represent carbon atoms of an unsubstituted XX group and does not include carbon atoms of a substituted XX group.

In addition, a terminal terminator, a branching agent and the like can be introduced to the polycarbonate resin contained in the coating agent in the exemplary embodiment.

As the terminal terminator, a monovalent carboxylic acid, a derivative thereof, a monovalent phenol and the like are usable. Examples of the terminal terminator include p-tert-butylphenol, p-phenylphenol, p-cumylphenol, p-perfluorononylphenol, p-(perfluorononylphenyl)phenol, p-perfluorooctylphenol, p-perfluoroheptylphenol, p-perfluorohexylphenol, p-perfluoropentylphenol, p-perfluorobutylphenol, p-tert-perfluorobutylphenol, 1-(p-hydroxybenzyl)perfluorodecane, p-[2-(1H,1H-perfluorotridodecyloxy)-1,1,1,3,3,3-hexafluoro propyl]phenol, 3,5-bis(perfluorohexyloxycarbonyl)phenol, p-hydroxyperfluorododecyl benzoate, p-(1H,1H-perfluorooctyloxy)phenol, 2H,2H,9H-perfluorononane acid, 1,1,1,3,3,3-hexaphloro-2-propanol, or alcohol fluorides represented by formulae (VII), (VIII), (IX) and (X) below.

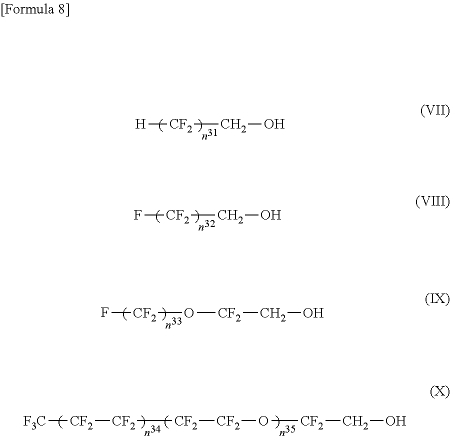

In the formula (VII), n³¹ is an integer from 1 to 12.

In the formula (VIII), n³² is an integer from 1 to 12.

In the formula (IX), n³³ is an integer from 5 to 8.

In the formula (X), n³⁴ is an integer from 0 to 2. n³⁵ is an integer from 1 to 3.

The polycarbonate resin having the terminal terminator therein is preferably a polycarbonate resin in which a part or all of molecular terminals are structured to be terminated by a phenol including a perfluoroalkyl group, a phenol including a terminal-hydrogen-substituted perfluoroalkyl group, 1,1-dihydro-1-perfluoroalkyl alcohol, 1,1,ω-trihydro-1-perfluoroalkylalcohol or the like. By introducing the above fluorine-containing alcohol at the terminal(s), water-oil repellency, lubricity and the like can be provided to the polycarbonate resin.

In the exemplary embodiment, an addition ratio of the terminal terminator is, in terms of a copolymerization composition ratio, preferably in a range from 0.05 mol % to 30 mol %, further preferably in a range from 0.1 mol % to 10 mol %. When the addition ratio of the terminal terminator is 0.05 mol % or more, moldability is favorable. When the additive ratio is 30 mol % or less, the mechanical strength is favorable.

Examples of the branching agent are phloroglucin, pyrogallol, 4,6-dimethyl-2,4,6-tris(4-hydroxyphenyl)-2-heptene, 2,6-dimethyl-2,4,6-tris(4-hydroxyphenyl)-3-heptene, 2,4-dimethyl-2,4,6-tris(4-hydroxyphenyl)heptane, 1,3,5-tris(2-hydroxyphenyl)benzene, 1,3,5-tris(4-hydroxyphenyl)benzene, 1,1,1-tris(4-hydroxyphenyl)ethane, tris(4-hydroxyphenyl)phenylmethane, 2,2-bis[4,4-bis(4-hydroxyphenyl)cyclohexyl]propane, 2,4-bis[2-bis(4-hydroxyphenyl)-2-propyl]phenol, 2,6-bis(2-hydroxy-5-methylbenzyl)-4-methylphenol, 2-(4-hydroxyphenyl)-2-(2,4-dihydroxyphenyl)propane, tetrakis(4-hydroxyphenyl)methane, tetrakis[4-(4-hydroxyphenyl isopropyl)phenoxy]methane, 2,4-dihydroxybenzoic acid, trimesic acid, cyanuric acid, 3,3-bis(3-methyl-4-hydroxyphenyl)-2-oxo-2,3-dihydroindole, 3,3-bis(4-hydroxyaryl)oxyindole, 5-chloroisatin, 5,7-dichloroisatin and 5-bromoisatin.

In the exemplary embodiment, an addition amount of the branching agent is, in terms of a copolymerization composition ratio, preferably 30 mol % or less, more preferably 5 mol % or less. When the addition amount of the branching agent is 30 mol % or less, moldability is favorable.

Although an appropriate range of a molecular weight of the polycarbonate resin in the exemplary embodiment is different depending on usage and the like of the coating liquid, generally, from the view point of moldability, a reduced viscosity [ηₛₚ/C] at 20 degrees C. of a solution where the polycarbonate resin is dissolved in a solvent of methylene chloride at a concentration of 0.5 g/dl is preferably in a range from 0.2 dl/g to 2 dl/g, more preferably in a range from 0.2 dl/g to 1 dl/g.

A film thickness of the polycarbonate resin layer 3 is preferably in a range from 1 μm to 100 μm, more preferably in a range from 2 μm to 20 μm, although the film thickness is different depending on the usage and intended use of the laminate 1. When the film thickness of the polycarbonate resin layer 3 is 100 μm or more, it is difficult to remove a solvent contained in the coating liquid when drying the polycarbonate resin layer 3.

The polycarbonate resin contained in the coating liquid in the exemplary embodiment preferably has the glass transition temperature of 150 degrees C. or less. The glass transition temperature of the polycarbonate resin is preferably in a range from 110 degrees C. to 150 degrees C. in terms of heat resistance required for an optical member and an electronic member.

### Manufacturing Method of Polycarbonate Resin

Next, a manufacturing method of the polycarbonate resin contained in the coating liquid in the exemplary embodiment will be described.

For instance, a manufacturing method of the polycarbonate resin having the repeating units represented by the formulae (I) and (II) will be described.

The polycarbonate resin can be manufactured by polymerizing the bisphenol E alone or by reacting the bisphenol E, 4,4′-biphenol or 4,4′-dihydroxydiphenylether with a carbonate precursor (e.g., phosgene) by an interfacial polymerization method.

Alternatively, the polycarbonate resin can be manufactured by a known non-phosgene method (e.g., transesterification method).

Specifically, the polycarbonate resin is manufactured by reacting the bisphenol E with the carbonate precursor (e.g., phosgene) or by reacting the bisphenol E, 4,4′-biphenol or 4,4′-dihydroxydiphenylether with the carbonate precursor, in an inactive solvent such as methylene chloride under presence of a known acid receptor and molecular weight modifier (corresponding to the terminal terminator) with addition of a catalyst and the branching agent as needed.

A variety of inactive solvents are usable as the inactive solvent. Examples of the inactive solvent include chlorinated hydrocarbon, toluene and acetophenone. Examples of chlorinated hydrocarbon include dichloromethane (methylene chloride), trichloromethane, carbon tetrachloride, 1,1-dichloroethane, 1,2-dichloroethane, 1,1,1-trichloroethane, 1,1,2-trichloroethane, 1,1,1,2-tetrachloroethane, 1,1,2,2-tetrachloroethane, pentachloroethane, and chlorobenzene.

One of the above inactive solvents may be used alone, or two or more thereof may be used in combination. Among the above, methylene chloride is favorable.

As the catalyst, a phase transfer catalyst such as a tertiary amine, a tertiary amine salt, a quaternary ammonium salt, and a quaternary phosphonium salt is preferably usable.

Examples of the tertiary amine include triethylamine, tributylamine, N,N-dimethylcyclohexylamine, pyridine, and dimethylaniline.

Examples of the tertiary amine salt include hydrochloride and bromate of the tertiary amine.

Examples of the quaternary ammonium salt include trimethylbenzyl ammonium chloride, triethylbenzyl ammonium chloride, tributylbenzyl ammonium chloride, trioctylmethyl ammonium chloride, tetrabutyl ammonium chloride, and tetrabutyl ammonium bromide.

Examples of the quaternary phosphonium salt include tetrabutyl phosphonium chloride and tetrabutyl phosphonium bromide.

One of the above catalysts may be used alone, or two or more thereof may be used in combination. Among the above catalysts, the tertiary amine is preferable and triethylamine is more preferable.

As the acid receptor, sodium hydroxide is typically used.

The polycarbonate resin contained in the coating liquid in the exemplary embodiment can be thus manufactured. The thus obtained polycarbonate resin exhibits an excellent solvent solubility and can be stably dissolved in a non-halogen solvent.

### Coating Liquid

Next, the coating liquid in the exemplary embodiment will be described.

The coating liquid in the exemplary embodiment contains: at least one of the above polycarbonate resin A, polycarbonate resin B and polycarbonate resin C: and a non-halogen solvent. The coating liquid in the exemplary embodiment preferably contains: at least one of the polycarbonate resin A and polycarbonate resin B: and a non-halogen solvent.

The non-halogen solvent forming the coating liquid in the exemplary embodiment is preferably at least one selected from an aromatic solvent, ether solvent, ketone solvent and ester solvent in terms of solubility.

Examples of the aromatic solvent include toluene, xylene, anisole, trimethyl benzene, and other aromatic high boiling point solvent (e.g., “IPSOL” (trade name, manufactured by Idemitsu Kosan Co., Ltd.).

Examples of the ether solvent include tetrahydrofuran, dioxane, cyclopentyl monomethylether, ethyleneglycol monomethylether acetate, propyleneglycol monomethylether acetate(PMA), diethyleneglycol monobutylether acetate, and diethyleneglycol monoethylether acetate.

Examples of the ketone solvent include cyclohexanone, methylisobutylketone, methyl ethyl ketone, and diisobutylketone.

Examples of the ester solvent include acetic ether, ethyl cellosolve, methyl acetate, butyl acetate, methoxybutyl acetate, cellosolve acetate, amyl acetate, normal propyl acetate, isopropyl acetate, methyl lactate, ethyl lactate, and butyl lactate.

Examples of the amide solvent include dimethyl formamide, dimethyl sulfoxide and diethyl formamide.

The non-halogen solvent used in the coating liquid in the exemplary embodiment is preferably the ketone solvent such as cyclohexanone and methylisobutylketone, or the ester solvent such as ethyl acetate, in terms of operation efficiency and safety. Further, the solvent used in the coating liquid in the exemplary embodiment is preferably at least one of the ketone solvent having a boiling point of 100 degrees C. or less and the ester solvent having a boiling point of 100 degrees C. or less, more preferably methyl ethyl ketone and ethyl acetate, in terms of easy drying and a decrease in a residual amount of the solvent in a molded article.

One of the non-halogen solvents may be used alone, or two or more thereof may be used in combination in order to obtain an optimum film condition by adjusting a drying rate.

A concentration of the coating liquid in the exemplary embodiment can be adjusted according to the coating film thickness and the molecular weight of the resin. The concentration of the coating liquid is preferably in a range from 1 mass % to 50 mass %, more preferably in a range from 1 mass % to 30 mass %, further preferably in a range from 5 mass % to 25 mass %. When the concentration is 1 mass % or more, productivity of the molded article is favorable. When the concentration is 50 mass % or less, an increase in a viscosity is suppressed and application of the coating liquid is not difficult.

As the resin forming the coating liquid in the exemplary embodiment, one of the above polycarbonate resins A, B and C may be used alone, or two or more thereof may be used in combination. Moreover, depending on the intended use, other polycarbonate resin such as BisA copolymerized polycarbonate and BisZ copolymerized polycarbonate, a polyester resin, an acrylic resin, an urethane resin, a polyamide resin and the like are usable in a mixture.

Depending on further usage, additives below may be added to the coating liquid in the exemplary embodiment.

A coloring agent is exemplified by dye and pigment.

Examples of a functional compound include an electroconductive material, charge transporting material, electron transporting material, hole transporting material and charge generating material.

A filler is exemplified by an inorganic or organic filler, examples of which include titanium oxide, silica, zinc oxide, zirconia oxide, alumina, carbon black, and phthalocyanine pigment. The filler is formed in a filler, fiber, particle and the like.

Examples of an antioxidant include a hindered phenolic antioxidant, phosphite antioxidant, phosphate antioxidant, and amine antioxidant.

Examples of an ultraviolet absorber include benzotriazole ultraviolet absorber and a benzophenone ultraviolet absorber.

A light stabilizer is exemplified by a hindered amine light stabilizer.

Examples of an internal lubricant include an aliphatic carboxylic acid ester-based internal lubricant, paraffinic internal lubricant, silicone oil and polyethylene wax.

In addition, various additives such as a typical mold releasing agent and an antistatic agent may be added to the coating liquid in the exemplary embodiment.

In the polycarbonate resin in the exemplary embodiment, the additives can be dissolved or dispersed stably and uniformly in the coating liquid and the coated film.

### Application of Laminate

The laminate 1 in the exemplary embodiment is usable for various applications in view of transparency, appropriate heat resistance and mechanical strength. As a preferable example of the application of the laminate 1 in the exemplary embodiment, the laminate 1 is used for an optical device and an electronic device. For instance, the laminate 1 is usable for a display component such as an organic EL panel module and a display device such as a TV, mobile phone, and tablet or personal computer. Moreover, the laminate 1 is usable for an illuminator or a light-emitting unit of an automobile lamp fitting.

When the resin base material 2 is in a form of a film in the laminate 1 in the exemplary embodiment, the laminate 1 in a form of a laminate film is applicable to a film for in-mold forming and a decorative film. In addition, the laminate film is also applicable to a touch panel film used for a liquid crystal display and an organic EL display, an optical film such as an optical compensation film and an antireflection film, and an electroconductive film.

### Advantage(s) of Embodiment(s)

According to the exemplary embodiment, the following advantages can be obtained.

The coating liquid in the exemplary embodiment contains: the polycarbonate resin at least having the repeating unit represented by the formula (I) derived from bisphenol E; and the non-halogen solvent. Accordingly, the coating liquid in the exemplary embodiment exhibits an excellent coating performance to a generally usable resin base material such as a polycarbonate resin, polyethylene terephthalate resin, acrylic resin, and polyolefin resin.

Further, according to the coating liquid in the exemplary embodiment, a residual solvent in the coated film is easily removable, so that the coating liquid can be dried for a short time while deformation and discoloration of the resin base material 2 are suppressed.

The laminate 1 in the exemplary embodiment includes the resin base material 2 having the glass transition temperature of 150 degrees C. or less and the polycarbonate resin layer 3 formed by applying the coating liquid in the exemplary embodiment to the resin base material 2. Accordingly, the laminate 1 contains less residual solvent to be able to be dried for a short time while deformation and discoloration of the resin base material 2 are suppressed and exhibits excellent mechanical strength (e.g., tensile strength), appearance and electrical characteristics. Accordingly, the laminate 1 is useful as a member for the optical device and a member for the electronic device

Moreover, the laminate 1, even in a form of a laminate film molded by the in-mold forming method, exhibits a favorable moldability and can be suppressed from deformation (e.g., flexure) and discoloration.

### Modifications of Embodiment(s)

It should be noted that the invention is not limited to the above exemplary embodiment but may include any modification and improvement as long as such modification and improvement are compatible with the invention.

For instance, the polycarbonate resin layer in the laminate is not limited to a single layer, but may be provided by a plurality of layers. The plurality of polycarbonate resin layers may be laminated on each other, or may be respectively provided on a top surface and a rear surface of the resin base material, when the resin base material is provided in a film or a sheet having the top and rear surfaces.

Moreover, the laminate may have a layer other than the polycarbonate resin layer(s). In the above exemplary embodiment, the arrangement in which the polycarbonate resin layer is directly laminated on the resin base material is described, but the arrangement of the laminate is not limited thereto. Another layer may be interposed between the polycarbonate resin layer and the resin base material, or another layer may be laminated on the polycarbonate resin layer.

The resin base material may be provided by laminating a plurality of layers. In the resin base material having the plurality of layers, the glass transition temperature of a layer of the resin base material on which the polycarbonate resin layer is laminated is preferably 150 degrees C. or less.

Further, the specific arrangements and configurations for implementing the invention may be altered in any manner as long as the modifications and improvements are compatible with the invention.

### EXAMPLES

Next, the invention will be further described in detail with reference to Examples, which by no means limit the invention.

A reduced viscosity, chemical structure and copolymerization composition ratio of the polycarbonate resin obtained in each of Examples and characteristics of a film obtained in each of Examples were measured according to methods below.

### Characteristics of Polycarbonate Resin

### Measurement 1: Reduced Viscosity [η_{SP}/C]

A polycarbonate resin was dissolved in methylene chloride (solvent) at a concentration of 0.5 g/dl to prepare a solution. The reduced viscosity [η_{SP}/C] of the solution was measured at 20 degrees C. using an Ubbelohde modified viscometer (RM type) designed for an automatic viscosity tester “VMR-052USPC” (model name, manufactured by RIGO Corp.).

### Measurement 2: Chemical Structure and Copolymerization Composition

The chemical structure and copolymerization composition of the polycarbonate resin were determined using a proton nuclear magnetic resonance spectrometer (¹H-NMR) (“JNM-AL400” (model name, manufactured by JEOL Ltd.).

### Characteristics of Film Cast on Glass Petri Dish

### Measurement 3: Glass Transition Temperature

A film was heated at a heating rate of 10 degrees C./minute using a differential scanning calorimeter “DSC220” (model name, manufactured by SEICO electronics industrial Co., Ltd.) under nitrogen gas stream (flow rate: 20 ml/minute) at temperatures from 25 degrees C. to 350 degrees C. Immediately subsequently, the film was rapidly cooled to remove thermal hysteresis. Further, the film was heated at the same heating rate as the above and a glass transition temperature was measured in accordance with JIS-K7121.

### Measurement 4: Tensile Test of Film

A tensile test of the film was conducted at 25 degrees C. under conditions of a tensile rate of 1 mm/s using a tensile tester “EZ GRAPH” (model name, manufactured by Shimadzu Corporation) in accordance with JIS-K7262 to measure an elastic modulus (unit: N/mm²) and a breaking elongation (unit: %).

### Characteristics of Laminate Film

### Measurement 5: Measurement of Residual Solvent

A laminate film manufactured by applying a coating liquid to a resin base material was cut out. A residual solvent in the cut laminate film was measured by a head space gas chromatography method (at a heating temperature of 150 degrees C. for 10 minutes) and was calculated as a concentration by mass of the laminate film.

### Synthesis of Polycarbonate Resin

### Synthesis Example 1

### Polycarbonate Resin (A-1) (BisE-BP)

A solution prepared by dissolving 0.17 kg of 1,1-bis(4-hydroxyphenyl)ethane (bisphenol E) in 1.2 kg of aqueous sodium hydroxide having a concentration of 11 mass % was mixed with 1.1 kg of methylene chloride. Then, while the solution was being stirred and cooled, phosgene gas was blown into the solution at 1 L/min until pH became 9 or less. Subsequently, the reaction solution was separated in a stand still manner. A methylene chloride solution of an oligomer having a polymerization degree of 2 to 6 and a chloroformate group at its molecular terminals was obtained as an organic layer. A mol concentration of chloroformate was 0.69 mol/L and a solid concentration thereof was 0.25 kg/L.

Next, 185 ml of methylene chloride and 0.8 g of p-tert-butylphenol were added to 269 ml of the oligomer solution. To the obtained solution, a solution in which 16 g of 4,4′-biphenol was dissolved in an aqueous sodium hydroxide having 2 mol/L concentration was added. Subsequently, 1.5 ml of a triethylamine aqueous solution having a concentration of 7 mass % was added as a catalyst to the obtained mixture while vigorously stirring the mixture. The obtained solution was reacted at 15 degrees C. for 1.5 hours while being stirred. After the reaction, the reaction product was diluted with 1000 ml of methylene chloride. Then, the reaction product was washed twice with 200 ml of water, once with 200 ml of hydrochloric acid having a concentration of 0.01 mol/L, and further twice with 200 ml of water in this order. After cleaning, the obtained organic layer was put into methanol and subjected to purification by reprecipitation, so that a polycarbonate resin (A−1) shown below was obtained.

The thus obtained polycarbonate resin (A−1) was dissolved in methylene chloride (solvent) to prepare a solution having a concentration of 0.5 g/dl. A reduced viscosity [η_{SP}/C] at 20 degrees C. of the solution was 1.1 dl/g.

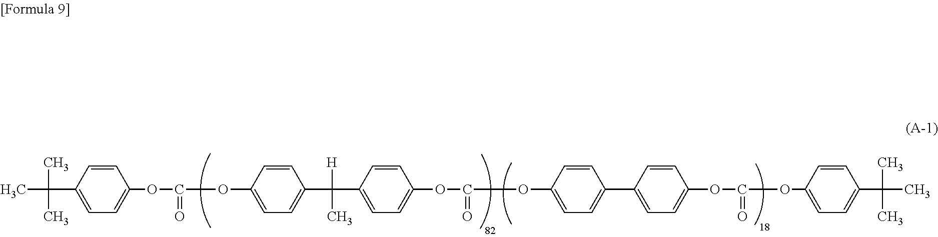

### Synthesis Example 2

### Polycarbonate Resin (A-2)

Synthesis Example 2 was conducted in the same manner as in Synthesis Example 1, except for using 22 g of 2,2-bis-(3-methyl-4-hydroxyphenyl)propane in place of 4,4′-biphenol, so that a polycarbonate resin (A-2) shown below was obtained.

The thus obtained polycarbonate resin (A-2) was dissolved in methylene chloride (solvent) to prepare a solution having a concentration of 0.5 g/dl. A reduced viscosity [η_{SP}/C] at 20 degrees C. of the solution was 1.0 dl/g.

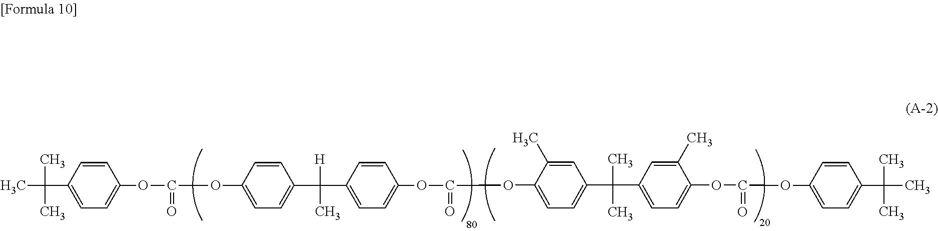

### Synthesis Example 3

### Polycarbonate Resin (A-3)

Synthesis Example 3 was conducted in the same manner as in Synthesis Example 1, except for changing an addition amount of p-tertbutylphenol to 4.6 g, so that a polycarbonate resin (A-3) was obtained.

The thus obtained polycarbonate resin (A-3) was dissolved in methylene chloride (solvent) to prepare a solution having a concentration of 0.5 g/dl. A reduced viscosity [η_{SP}/C] at 20 degrees C. of the solution was 0.5 dl/g.

### Preparation of Coating Liquid

### Manufacturing Example 1

### Coating Liquid 1

The polycarbonate resin (A-1) obtained in Synthesis Example 1 was mixed with cyclohexanone so as to have a concentration of 20 mass %, so that a coating liquid 1 containing a polycarbonate resin solution containing the polycarbonate resin (A-1) and cyclohexanone was prepared.

### Manufacturing Example 2

### Coating Liquid 2

The polycarbonate resin (A-1) obtained in Synthesis Example 1 was mixed with cyclohexanone so as to have a concentration of 20 mass % to provide a solution, in the same manner as in Manufacturing Example 1. Particles of titanium oxide having an average diameter of 10 nm were dispersed in the solution so as to account for 20 mass %, so that a coating liquid 2 was prepared.

In Manufacturing Example 2, the average diameter of each of the particles is a measurement value by a light-scattering-particle diameter measuring device.

### Manufacturing Example 3

### Coating Liquid 3

A coating liquid 3 was prepared in the same manner as in Manufacturing Example 1 except for using the polycarbonate resin (A-2) obtained in Synthesis Example 2 in place of the polycarbonate resin (A−1).

### Manufacturing Example 4

### Coating Liquid 4

A coating liquid 4 was prepared in the same manner as in Manufacturing Example 2 except for using the polycarbonate resin (A-2) in place of the polycarbonate resin (A−1).

### Manufacturing Example 5

### Coating Liquid 5

A coating liquid 5 was prepared in the same manner as in Manufacturing Example 1, except that a polycarbonate resin (D) having a repeating unit of bisphenol Z (1,1-bis(4-hydroxyphenyl)cyclohexane) below was used in place of the polycarbonate resin (A-1) of Manufacturing Example 1, in which a reduced viscosity [η_{SP}/C] at 20 degrees C. of the polycarbonate resin (D) dissolved in methylene chloride (solvent) so as to have a concentration of 0.5 g/dl was 1.1 dl/g.

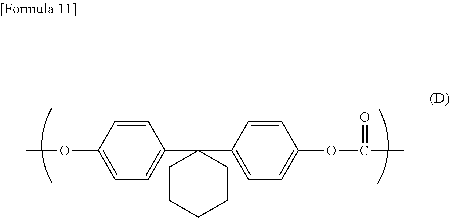

### Manufacturing Example 6

### Coating Liquid 6

A coating liquid 6 was prepared in the same manner as in Manufacturing Example 2 except for using the polycarbonate resin (D) in place of the polycarbonate resin (A-1).

### Manufacturing Example 7

### Coating Liquid 7

The polycarbonate resin (A-3) obtained in Synthesis Example 3 was mixed with methyl ethyl ketone so as to have a concentration of 20 mass %, so that a coating liquid 7 of a polycarbonate resin solution containing the polycarbonate resin (A-3) and methyl ethyl ketone was prepared.

### Manufacturing Example 8

### Coating Liquid 8

The polycarbonate resin (A-3) obtained in Synthesis Example 3 was mixed with methyl ethyl ketone so as to have a concentration of 20 mass % to provide a solution, in the same manner as in Manufacturing Example 7. Particles of silica having an average diameter of 10 nm were dispersed in the solution so as to account for 20 mass %, so that a coating liquid 8 was prepared.

### Manufacturing Example 9

Preparation of a coating liquid was attempted by mixing the polycarbonate (D) in methyl ethyl ketone so as to have a concentration of 20 mass %. However, since the resin was not dissolved, preparation of the coating liquid was difficult.

### Preparation of Cast Film

### Example 1

The coating liquid 1 was cast on a glass petri dish so as to have a film thickness of about 100 μm. It was observed that a uniformly transparent film was formed in terms of film conditions at this time.

After the obtained film was heated and dried at 130 degrees for 48 hours under a reduced pressure, a glass transition temperature of the film was measured. Further, a tensile test was conducted to measure an elastic modulus and a breaking elongation. The results are shown in Table 1.

### Example 2

A film was manufactured by casting in the same manner as in Example 1 except for using the coating liquid 2 in place of the coating liquid 1 of Example 1. It was observed that a uniformly white film was formed. The same test and measurement as those in Example 1 were conducted to measure the elastic modulus and the breaking elongation. The results are shown in Table 1.

### Example 3

A film was manufactured by casing in the same manner as in Example 1 except for using the coating liquid 3 in place of the coating liquid 1 of Example 1. It was observed that a uniformly transparent film was formed. The same test and measurement as those in Example 1 were conducted. The results are shown in Table 1.

### Example 4

A film was manufactured by casing in the same manner as in Example 1 except for using the coating liquid 4 in place of the coating liquid 1 of Example 1. It was observed that a uniformly white film was formed. The same test and measurement as those in Example 1 were conducted to measure the elastic modulus and the breaking elongation. The results are shown in Table 1.

### Example 5

A film was manufactured by casing in the same manner as in Example 1 except for using the coating liquid 7 in place of the coating liquid 1 of Example 1. It was observed that a uniformly transparent film was formed. A glass transition temperature of the film was measured. The results are shown in Table 1.

### Example 6

A film was manufactured by casing in the same manner as in Example 1 except for using the coating liquid 8 in place of the coating liquid 1 of Example 1. It was observed that a uniformly transparent film was formed. A glass transition temperature of the film was measured. The results are shown in Table 1.

### Comparative 1

A film was manufactured by casing in the same manner as in Example 1 except for using the coating liquid 5 in place of the coating liquid 1 of Example 1. It was observed that a uniformly transparent film was formed. The same test and measurement as those in Example 1 were conducted. The results are shown in Table 1.

### Comparative 2

A film was manufactured by casing in the same manner as in Example 1 except for using the coating liquid 6 in place of the coating liquid 1 of Example 1. When the coating liquid 6 was used, unevenness as formed by aggregation of titanium oxide was observed in a part of the film. The obtained film was subjected to the same test and measurement as in Example 1 to measure the elastic modulus and the breaking elongation. The results are shown in Table 1.

TABLE 1

| | | | | | Glass | Tensile Test | |
|---|---|---|---|---|---|---|---|
| | | Film | | | Transition | Elastic | Breaking |
| | Coating | Polycarbonate | Added | Film | Temperature | Modulus | Elongation |
| | Liquid | Resin | Particles | Appearance | (° C.) | (N/mm²) | (%) |
| Example 1 | 1 | (A-1) | none | uniformly | 148 | 1,950 | 120 |
| | | | | transparent | | | |
| Example 2 | 2 | (A-1) | titanium | uniformly | — | 2,300 | 70 |
| | | | oxide | white | | | |
| Example 3 | 3 | (A-2) | none | uniformly | 130 | 2,200 | 100 |
| | | | | transparent | | | |
| Example 4 | 4 | (A-2) | titanium | uniformly | — | 2,600 | 55 |
| | | | oxide | white | | | |
| Example 5 | 7 | (A-3) | none | uniformly | 130 | — | — |
| | | | | transparent | | | |
| Example 6 | 8 | (A-3) | silica | uniformly | — | — | — |
| | | | | transparent | | | |
| Comparative 1 | 5 | (D) | none | uniformly | 175 | 2,500 | 95 |
| | | | | transparent | | | |
| Comparative 2 | 6 | (D) | present | uneven | — | 2,800 | 40 |

As shown in Table 1, it is found that the polycarbonate resin films manufactured in Examples 1 to 4 have a lower glass transition temperature, more excellent filler dispersion performance and more excellent breaking elongation than those in the polycarbonate resin films manufactured in Comparatives 1 and 2. The polycarbonate resin films manufactured in Examples 5 and 6 have a lower glass transition temperature and more excellent filler dispersion performance than those in the polycarbonate resin films manufactured in Comparatives 1 and 2. The polycarbonate resin (A-1), polycarbonate resin (A-2), and polycarbonate resin (A-3) each have a specific structure of the polycarbonate resin according to the above exemplary embodiment. The polycarbonate resin films respectively formed by applying the coating liquids containing the polycarbonate resin (A-1), polycarbonate resin (A-2) or polycarbonate resin (A-3) have characteristics shown in Table 1. Accordingly, even when each of the coating liquids is applied to the resin base material to prepare the laminate, the polycarbonate resin layer is speculated to exhibit the same characteristics as those in Examples 1 to 6. On the other hand, since the polycarbonate resin (D) does not have the specific structure of the polycarbonate resin according to the above exemplary embodiment, it is speculated that Comparatives 1 and 2 show inferior characteristics to those of Examples 1 to 6.

### Example 7

The coating liquid 1 was applied on a polycarbonate resin film (resin base material) using an applicator. The polycarbonate resin film was formed of a polycarbonate resin obtained by polymerizing bisphenol A (starting material) and has the glass transition temperature of 145 degrees C. and a film thickness of 250 μm.

The resin base material on which the coating liquid 1 was applied was dried at 130 degrees C. for 10 minutes to form a polycarbonate resin layer having a film thickness of 20 μm, so that a laminate film was manufactured. No change in appearance and a form was observed. Subsequently, a residual solvent in the laminate film was measured. The residual solvent was measured as a ratio of a mass of cyclohexane to a mass of the laminate film. The results are shown in Table 2.

### Example 8

A laminate film in Example 8 was manufactured in the same manner as in Example 7 except for using the coating liquid 2 in place of the coating liquid 1 of Example 7. No change in appearance was observed. The residual solvent was measured in the same manner as in Example 7. The results are shown in Table 2.

### Example 9

A laminate film in Example 9 was manufactured in the same manner as in Example 7 except for using the coating liquid 7 in place of the coating liquid 1 of Example 7 and setting the drying temperature at 100 degrees C. No change in appearance was observed. The residual solvent was measured as a ratio of a mass of methyl ethyl ketone to a mass of the laminate film. The results are shown in Table 2.

### Example 10

A laminate film in Example 10 was manufactured in the same manner as in Example 7 except for using the coating liquid 8 in place of the coating liquid 1 of Example 7 and setting the drying temperature to 100 degrees C. No change in appearance was observed. The residual solvent was measured as a ratio of a mass of methyl ethyl ketone to a mass of the laminate film. The results are shown in Table 2.

### Comparative 3

A laminate film in Comparative 3 was manufactured in the same manner as in Example 7 except for using the coating liquid 5 in place of the coating liquid 1 of Example 7. No change in appearance was observed. The residual solvent was measured in the same manner as in Example 7. The results are shown in Table 2.

### Comparative 4

A laminate film in Comparative 4 was manufactured in the same manner as in Example 7 except for using the coating liquid 6 in place of the coating liquid 1 of Example 7. A slight unevenness was observed on appearance. The residual solvent was measured in the same manner as in Example 7. The results are shown in Table 2.

### Comparative 5

A laminate film in Comparative 5 was manufactured in the same manner as in Example 7 except for using the coating liquid 6 in place of the coating liquid 1 of Example 7. However, the film was dried at 155 degrees C. for 30 minutes. After the drying, discoloration of a surface of the film to yellow and deformation of the polycarbonate film were observed. The residual solvent was measured in the same manner as in Example 7. The results are shown in Table 2.

TABLE 2

| | | Polycarbonate Resin Layer | | | | |
|---|---|---|---|---|---|---|
| | Coating | Polycarbonate | Added | Drying | Laminate | Residual |
| | Liquid | Resin | Particles | Temp. (° C.) | Appearance | Solvent (%) |
| Example 7 | 1 | (A-1) | none | 130 | uniformly transparent, | 0.3 |
| | | | | | no deformation | |
| Example 8 | 2 | (A-1) | titanium | 130 | uniformly white, | 0.2 |
| | | | oxide | | no deformation | |
| Example 9 | 7 | (A-3) | none | 100 | uniformly transparent, | 0.08 |
| | | | | | no deformation | |
| Example 10 | 8 | (A-3) | silica | 100 | uniformly transparent, | 0.07 |
| | | | | | no deformation | |
| Comparative 3 | 5 | (D) | none | 130 | uniformly transparent, | 1.2 |
| | | | | | no deformation | |
| Comparative 4 | 6 | (D) | titanium | 130 | non-uniform, uneven, | 0.9 |
| | | | oxide | | no deformation | |
| Comparative 5 | 6 | (D) | titanium | 155 | discoloration to light | 0.3 |
| | | | oxide | | yellow, deformation | |

The laminates in Examples 7 and 8 each have the polycarbonate resin layer formed using the coating liquid containing the polycarbonate resin (A-1). Accordingly, as shown in Table 2, it is found that the laminates in Examples 7 and 8 contain less residual solvent and can be dried at low temperatures, so that deterioration of the polycarbonate resin film (base material) can be inhibited. On the other hand, in Comparatives 3 to 5, the polycarbonate resin layers are formed using the coating liquid containing the polycarbonate resin (D) and contain much residual solvent. Accordingly, in Comparative 5, when the drying temperature was increased, the base film was discolored to light yellow and deformed.

The coating liquid 7 and the coating liquid 8 each contain the polycarbonate resin (A-3) and methyl ethyl ketone having a lower boiling point than cyclohexanone. In the laminate of Example 9 using the coating liquid 7 and the laminate of Example 10 using the coating liquid 8, the residual solvent can be reduced at lower temperatures.

1. A laminate comprising:
a resin base material having a glass transition temperature of 150 degrees C. or less; and
a polycarbonate resin layer formed by applying a coating liquid containing a polycarbonate resin on the resin base material, wherein
the polycarbonate resin contained in the coating liquid has a repeating unit represented by a formula (I) below,

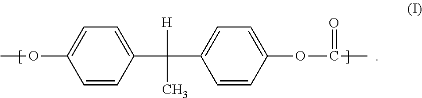

2. The laminate according to claim 1, wherein
the polycarbonate resin contained in the coating liquid has the repeating unit represented by the formula (I) and a repeating unit represented by a formula (II) below, 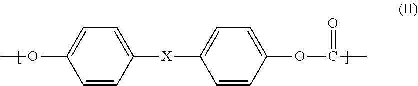
where: X is a single bond or an oxygen atom.

3. The laminate according to claim 1, wherein
the polycarbonate resin contained in the coating liquid has a glass transition temperature of 150 degrees C. or less.

4. The laminate according to claim 1, wherein
the resin base material is formed of at least one of the group consisting of a polycarbonate resin, a polyethylene terephthalate resin, a polyolefin resin and an acrylic resin.

5. The laminate according to claim 1, wherein
the coating liquid comprises a non-halogen solvent.

6. The laminate according to claim 5, wherein
the non-halogen solvent is at least one solvent selected from the group consisting of an aromatic solvent, an ether solvent, a ketone solvent and an ester solvent.

7. An optical device using the laminate according to claim 1.

8. An electronic device using the laminate according to claim 1.

9. A coating liquid comprising:
a polycarbonate resin having a repeating unit represented by a formula (I) below, and
at least one of a ketone solvent having a boiling point of 100 degrees C. or less and an ester solvent having a boiling point of 100 degrees C. or less,

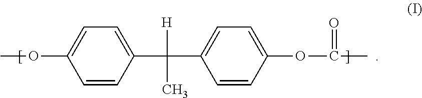

10. The coating liquid according to claim 9, wherein
the polycarbonate resin has the repeating unit represented by the formula (I) and a repeating unit represented by a formula (II) below, 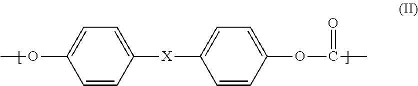
where: X is a single bond or an oxygen atom.

11. The coating liquid according to claim 9, wherein
the polycarbonate resin contained in the coating liquid has a glass transition temperature of 150 degrees C. or less.
